(19) United States
(12) Patent Application Publication
(10) Pub. No.: US 2002/0054796 A1
(43) Pub. Date: May 9, 2002

(54) Electric hand tool implement

(76) Inventor: Uto Plank, Freising (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/903,898

(22) Filed: Jul. 12, 2001

(30) Foreign Application Priority Data
Jul. 14, 2000 (DE) 10034378.3

(51) Int. Cl. B23B 45/02

(52) U.S. Cl. 408/9; 408/124

(57) ABSTRACT

An electrical hand operated tool driving device (1) for at least partially rotationally driving a tool has a tool chuck (3), at the front end of a housing (2) along with an operating handle (4) for an operator's hand (11), with the handle located adjacent to the tool chuck. A bearing surface (8), for supporting the electrical hand operated tool driving device (1) on the forearm associated with the operator's hand (11), is positioned in the rear end region of the housing (2) spaced from the tool chuck (3).

### BACKGROUND OF THE INVENTION

The invention relates to an electrical hand operated tool driving device, such as a drill, a hammer drill or jackhammer for at least partially rotationally driving a tool.

Conventional hammer drills, jackhammers and other drilling devices, presently on the market, are designed for two-handed operation. In practice, however, one-handed operation is frequently employed. Particularly for installation work, a free hand is frequently required for holding the object to be fastened, for holding another tool, or a template for drilling holes for dowels and screws, and the like.

The operating handle of drilling devices, designed for two-handed operation, is frequently far removed from the center of gravity of the drilling device. As a result, a one-handed operation results in a great stress on the wrist and the muscles of the arm of the operator. Likewise, because of the large distance between the operating hand and the workpiece, it is very difficult to connect a tool, which is seated at the front end of the device housing, since a small change in the angle at the wrist results in a large deflection at the tip of the tool.

According to U.S. Pat. No. 5,445,479, a drill for the one-handed operation has an operating handle, which is disposed in an extension of the tool axis behind the driving mechanism and oriented essentially perpendicularly thereto, as well as an arm support, which protrudes from the rear and in which the forearm of the operator's hand can be fastened with a cuff.

According to the DE 19930008 A1, a hand operated tool driving device, such as a drill, has an operating handle, which is disposed behind the driving mechanism and oriented essentially perpendicularly to it, as well as a forearm support for the operator's hand, which protrudes towards the rear, and has a concave shape for partially embracing the forearm.

In these previously known solutions, the whole weight of the hand operated tool driving device is absorbed by the operating hand, since the arm support serves only for adsorbing the torque, produced by the weight of the tool driving device projecting over the handle at the front. Furthermore, the operating handle, disposed behind the driving device, makes it difficult to connect the tool accurately. The use in a two-handed operation is not supported.

### SUMMARY OF THE INVENTION

It is a primary object of the invention to provide a solution for an electrical hand operated tool driving device, designed for one-handed operation, where the operating hand is freed from the burden of the weight of the tool driving device and, moreover, a tool can be connected more accurately. An additional refinement for two-handed operation is a further aspect.

Essentially, the operating handle of the electrical hand operated tool driving device is in front of the center of gravity. When the electric hand tool implement is used appropriately, there is an at least partially horizontal bearing surface for the forearm of the operator's hand at the lower rear end of the housing. As a result, the dead weight rests at least partially on the forearm.

Advantageously, the operating handle is combined with a switch for controlling the electrical hand operated tool driving device.

With respect to the position of the tool axis, the electrical hand operated tool driving device furthermore advantageously can be guided by a concave depression, which is disposed at the rear end of the housing and embraces the forearm.

Advantageously, a safety clutch, which responds to the torque of the tool and separates the tool driving mechanism from the tool clutch under excessive torque, is adjusted for a relatively low limiting torque, relative to the counter-torque of the forearm, as a result of which a tool blockage is not critical for the tool operator. Accordingly, the electrical hand operated tool driving device can also be used non-critically in a one-handed operation with tools of large diameter, which occasionally cause a tool blockage.

A side handle, in addition is advantageously present, and alternatively makes two-handed operation possible in the case of tools of large diameter or of workpieces, which are difficult to process.

Furthermore, advantageously the side handle is equipped with a switching key, which cannot be locked, for switching the limiting torque of the safety clutch to a higher value, permissible for the two-handed operation. For this purpose, the second hand must necessarily take hold of the side handle.

Advantageously, the electrical hand operated tool driving device has electrical accumulators for supplying energy independently of the electrical network. Preferably these electrical accumulators are disposed in the rear part of the electrical hand operated tool driving device. As a result, their weight is taken up essentially by the forearm.

### BRIEF DESCRIPTION OF THE DRAWING

The invention is described in greater detail with respect to an advantageous embodiment, in which:

FIG. 1 is a perspective side view of an electrical hand operated tool driving device.

### DETAILED DESCRIPTION OF THE INVENTION

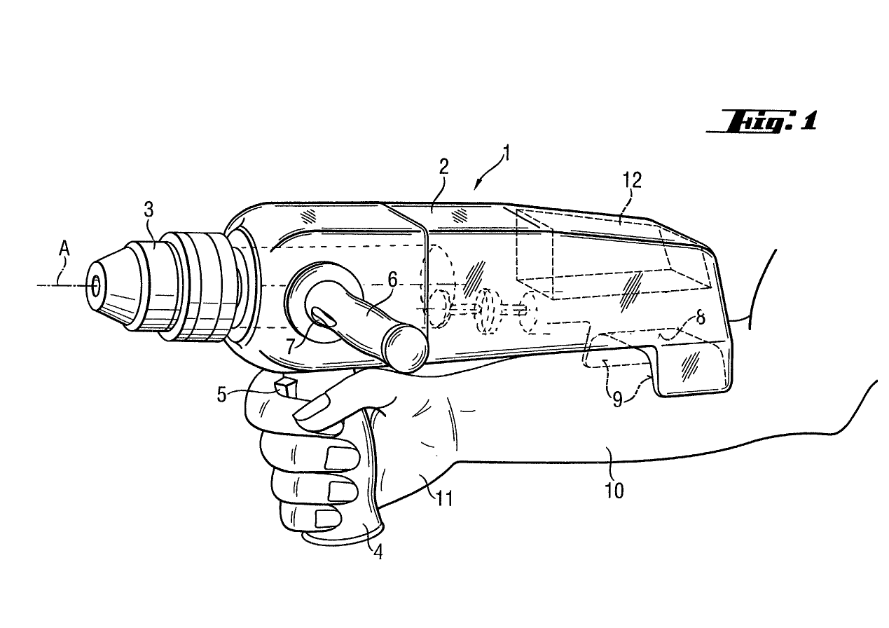

In FIG. 1, an electrical hand operated tool driving device 1 has a housing 2 with a tool chuck 3 in its front region for securing a tool, not shown and rotatable at least partially about an axis A. An operating handle 4 is located in the front region of the housing 2 close to the tool chuck 3 and, accordingly, in front of the center of gravity of the tool driving device 1 and below the housing 2 it extends essentially perpendicularly to the axis A and, accordingly, is disposed vertically during normal use, and includes a control switch 5. A side handle 6 with a switching key 7, is located perpendicularly to the operating handle 4 and to the axis A. A support or bearing surface 8, is arranged in the rear region of the housing 2, and is partially horizontal during normal use and supports the forearm 10 of an operator's hand 11, grasping the operating handle 4, with two guiding surfaces 9, which are perpendicular to the support surface 8 and, together with the bearing surface 8, form an at least partly concave depression for the forearm 10 affording lateral guidance of the electrical hand operated tool driving device 1. In addition an electrical accumulator 12 is disposed in the rear region in the interior of the housing 2.

What is claimed as new and desired to be protected by letters patent is set forth in the appended claims.

What is claimed is:

1. An electrical hand operated tool driving device for at least partially rotationally driving a tool comprises an elongated housing (2) having a front end and a rear end spaced apart in the elongated direction, a tool chuck (3) for holding the tool located at the front end of the housing (2), an operating handle (4) to be gripped by an operating hand (11) of the device operator, said operating handle (4) is located on and projects outwardly from said housing (2) adjacent said tool chuck (3), a support part (8) on said housing adjacent the rear end of said housing and arranged to support said device on the forearm of the device operator.

2. An electrical hand operated tool driving device, as set forth in claim 1, wherein said operating handle (4) includes a control switch.

3. An electrical hand operated tool driving device, as set forth in claim 1, wherein said support part (8) comprises a concave shaped member on a downwardly facing surface of said housing.

4. An electrical hand operated tool driving device, as set forth in claim 1, comprising a tool driving mechanism within said housing for driving the tool, a safety clutch within said housing located between said tool driving mechanism and said tool chuck and responding to the torque driving the tool for separating the tool driving mechanism from said tool chuck under the presence of excessive torque.

5. An electrical hand operated tool driving device, as set forth in claim 1, wherein a side handle (6) is connected to and extends laterally outwardly from said housing.

6. An electrical hand operated tool driving device, as set forth in claim 5, wherein said side handle (6) includes a switching key incapable of being locked for switching the limiting torque of said safety clutch.

7. An electrical hand operated tool driving device, as set forth in claim 1, wherein an electrical accumulator is located within said housing.

8. An electrical hand operated tool driving device, as set forth in claim 7, wherein said electrical accumulator is located within said housing (2) in the region adjacent the rear end of said housing.
